(19) United States
(12) Patent Application Publication
(10) Pub. No.: US 2026/0318151 A1
(43) Pub. Date: Oct. 15, 2026

(54) ELECTROMECHANICAL ACTUATOR, MOTOR-BASED DRIVING DEVICE AND CONCEALMENT DEVICE COMPRISING SUCH AN ACTUATOR, AND METHOD FOR ASSEMBLING SUCH AN ACTUATOR

(71) Applicant: SOMFY ACTIVITES SA, CLUSES (FR)

(72) Inventors: Jibin QIAN, Nanxun Huzhou (CN); Xingkun LIU, Nanxun Huzhou (CN)

(21) Appl. No.: 19/461,889

(22) Filed: Jan. 28, 2026

(30) Foreign Application Priority Data
Jan. 28, 2025 (FR) 2500891

(51) Int. Cl. E06B 9/80; E06B 9/42; E06B 9/72

(52) U.S. Cl. CPC E06B 9/80; E06B 9/42; E06B 9/72; E06B 2009/801

(57) ABSTRACT

An electromechanical actuator of a concealment device comprising at least an electric motor configured to drive an output shaft (42) of the actuator in rotation around an axis of rotation (X42) and a kinematic coupling wheel (44) between the output shaft and a winding tube of a screen. The output shaft (42) is equipped with a lock, pivoting around a pivot axis (Y42) radial to the axis of rotation (X42) between a first position, compatible with the placement of the coupling wheel (44) on the output shaft, and a second position, for maintaining the coupling wheel in axial position on the output shaft.

This invention relates to an electromechanical actuator of a concealment device, as well as a motor-based driving device for driving a screen of a concealment device, comprising such an electromechanical actuator. The present invention also relates to a concealment device comprising such a motor-based driving device, as well as a method for assembling an electromechanical actuator.

The technical field of the present invention is that of concealment devices which comprise a motor-based driving device moving a screen between a first position and at least a second position.

In this type of device, it is known to transmit a rotational movement from an output shaft of the electromechanical actuator toward a winding shaft of a screen, by means of a coupling wheel configured to transmit torque between the output shaft and the winding shaft.

To fulfill its function, the coupling wheel must be mounted on, and immobilized in rotation and translation with, the output shaft of the electromechanical actuator. To do this, it is known to use more or less complex mechanical systems ensuring notably an axial retention of the coupling wheel on the output shaft.

BE1028383A1 instructs, for example, using a screw and an axial locking element to secure a wheel to an output shaft of an actuator. FR2934006A1 is based on a similar principle, for assembling two parts of a drive wheel together. It is, furthermore, known from WO2005/033464A1, WO2006/061349A1, WO2005/033464A1, and EP2314824A1 to use elastically deformable clips to retain a coupling wheel on an output shaft of an electromechanical actuator.

According to another technique, a groove is provided in the output shaft of the electromechanical actuator, and a circlip is engaged in this groove to form a stop opposing axial separation between the coupling wheel and the output shaft. The circlip constitutes an independent part of the rest of the actuator that may be lost or fall to the ground during the assembly of the electromechanical actuator. During a maintenance operation of the electromechanical actuator, dismantling the circlip can be difficult and requires the use of a suitable tool.

The known systems are relatively complex to implement and require skilled labor.

This invention aims to particularly remedy these drawbacks by proposing a new electromechanical actuator the assembly of which is simplified and facilitated, while remaining reliable.

To this end, the invention relates to an electromechanical actuator of a concealment device, this actuator comprising at least an electric motor configured to drive an output shaft of the actuator in rotation around an axis of rotation and a kinematic coupling wheel between the output shaft and a winding tube of a screen. In accordance with the invention, the output shaft is equipped with a lock, pivoting around a pivot axis radial to the axis of rotation between a first position, compatible with the placement of the coupling wheel on the output shaft, and a second position, for maintaining the coupling wheel in an axial position on the output shaft.

By means of the invention, the pivoting lock can be pre-mounted on the output shaft of the electromechanical actuator prior to placing the coupling wheel around this shaft. It is then possible to place the coupling wheel on the output shaft. Then, a simple manipulation that does not require any special tool allows to displace the lock from its first position toward its second position, in which it effectively maintains the coupling wheel in an axial position on the output shaft. The placement and maintenance in position of the coupling wheel on the output shaft are facilitated and do not require highly skilled labor. Once it is pre-mounted on the output shaft, the lock is not at risk of being lost.

According to advantageous but non-mandatory aspects of the invention, such an electromechanical actuator can incorporate one or more of the following features taken according to any technically admissible combination:
The lock is an elastically deformable metal strip, globally U-shaped, notably of the circlip type.
The angular amplitude of the pivoting of the lock, around the pivot axis, between its first and second positions, is about 90°, a median plane of the lock is parallel to the axis of rotation when the lock is in its first position, and the median plane of the lock is perpendicular to the axis of rotation when the lock is in its second position.
The lock comprises two lugs and the output shaft comprises two diametrically opposed housings, configured to receive the lugs, with the possibility of rotation of the lugs in the housings allowing to pivot the lock between its first and second positions.
The lugs are arranged on plates located at the ends of the U branches, facing each other and extending toward each other.
Each lug extends from a plate of the lock; the output shaft defines at least a first notch for partial reception of a plate when the lock is in its first position; the output shaft defines at least a second notch for partial reception of the plate when the lock is in its second position; and a protruding relief separates the first and second notches.
The protruding relief is delimited by a chamfer on the side of the first notch and by a stop surface on the side of the second notch and the protruding relief opposes less the pivoting of the lock from its first position toward its second position than the pivoting of the lock from its second position toward its first position.
The output shaft comprises ribs for transmission of the torque to the coupling wheel, which is equipped with internal grooves for receiving the ribs of the output shaft, and, when it is in its first position, the lock is in the extension of at least one rib of the output shaft.

According to a second aspect, the invention relates to a motor-based driving device for driving a screen of a concealment device, between at least a first position and at least a second position, comprising a winding tube of the screen and an actuator as mentioned above, the coupling wheel of which is integral in rotation with the winding tube, around the axis of rotation.

According to a third aspect, the invention relates to a concealment device comprising a screen movable between at least a first position and at least a second position and a motor-based driving device for the screen between its first and second positions, such as described above.

According to a fourth aspect, the invention relates to a method for assembling an electromechanical actuator, in which
a) a pivoting lock is pre-mounted at one end of an output shaft of the electromechanical actuator, in a first position, compatible with the placement of a coupling wheel on the output shaft;
b) one end of the output shaft equipped with the pivoting lock is engaged in a central bore of the coupling wheel;
c) the coupling wheel is axially locked on the output shaft by pivoting the pivoting lock, around an axis radial to an axis of rotation of the output shaft, between its first position and a second position for maintaining the coupling wheel in an axial position on the output shaft.

The invention will be better understood, and other advantages thereof will appear more clearly in light of the following description of one embodiment of an electromechanical actuator, a motor-based driving device, a concealment device, and a method for mounting in accordance with its principle, given solely by way of example and made with reference to the appended drawings in which:

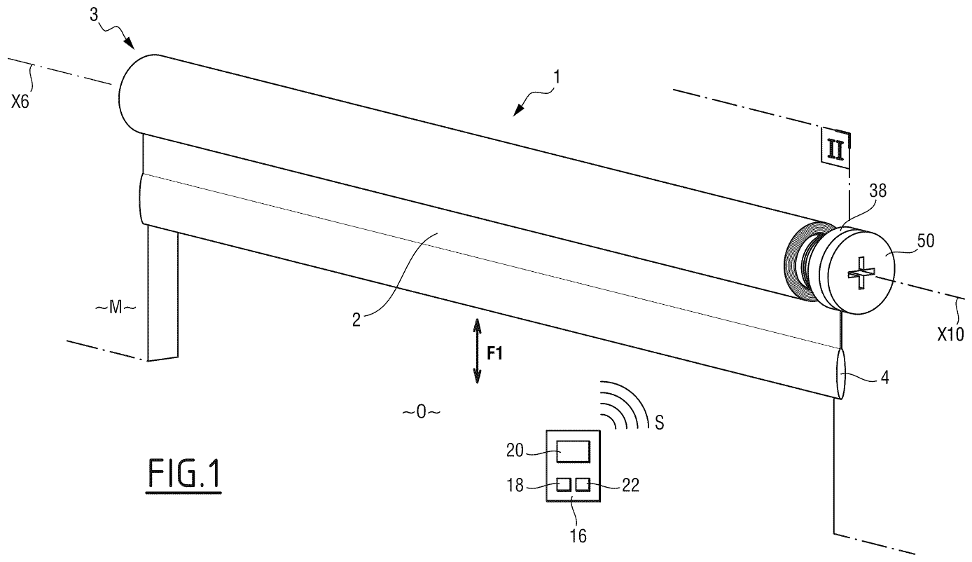

FIG. 1 is a partial schematic perspective view of a concealment device in accordance with the invention, incorporating an electromechanical actuator and a driving device also in accordance with the invention;

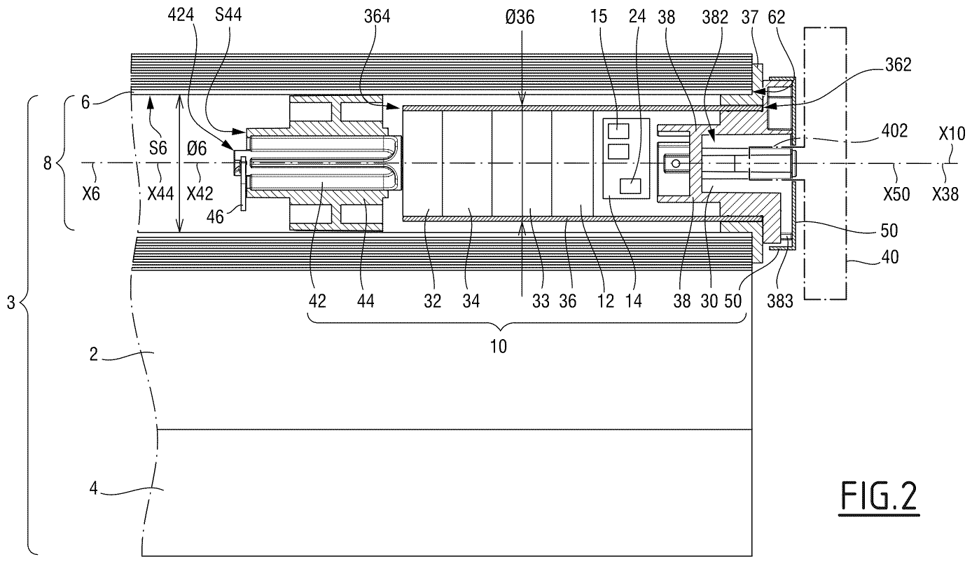

FIG. 2 is a partial section according to plane II in FIG. 1, notably showing the mechanical actuator;

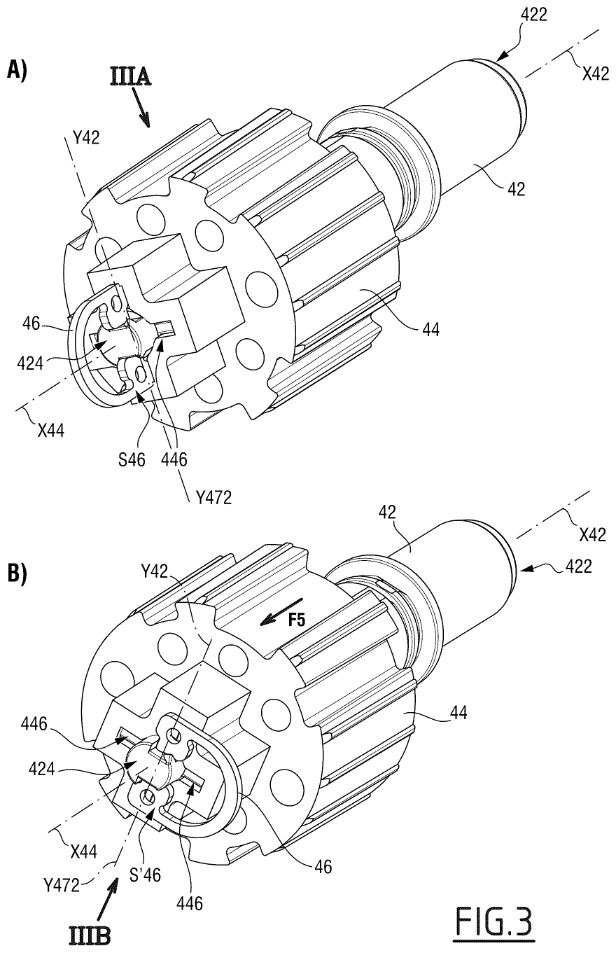

FIG. 3, represents in two inserts A) and B), perspective views of a drive wheel, an output shaft, and a pivoting lock belonging to the electromechanical actuator visible in FIG. 2;

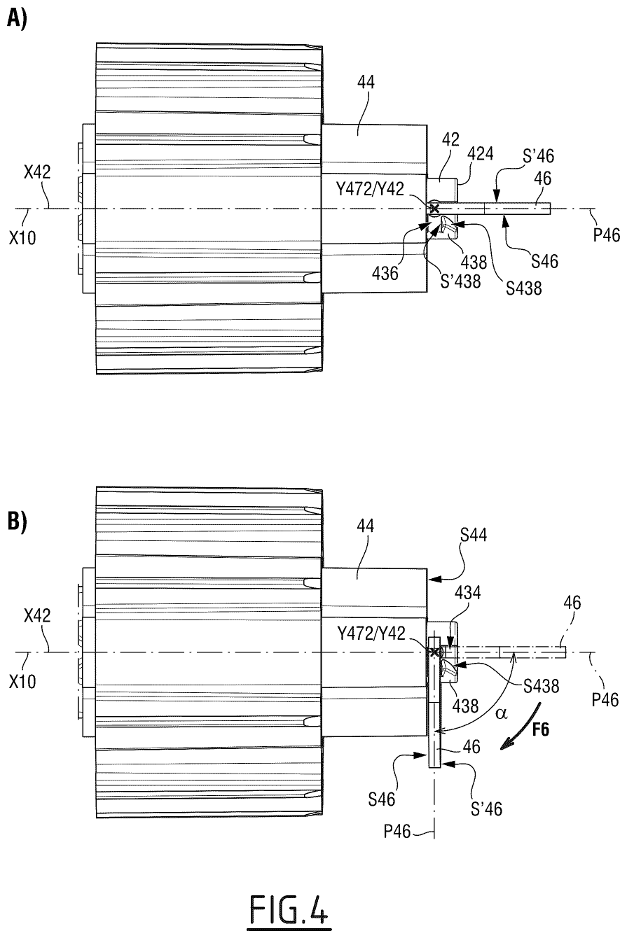

FIG. 4 represents, in two inserts A) and B), partial side views of the elements visible on inserts A) and B) of FIG. 3, respectively in the direction of arrows IIIA and IIIB;

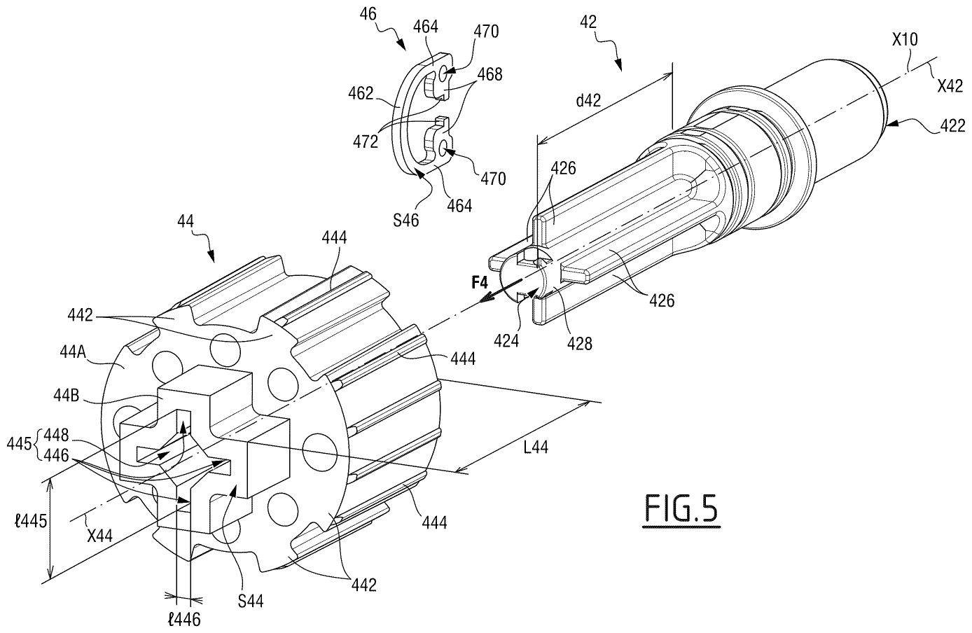

FIG. 5 is an exploded perspective view of the elements visible in FIGS. 3 and 4;

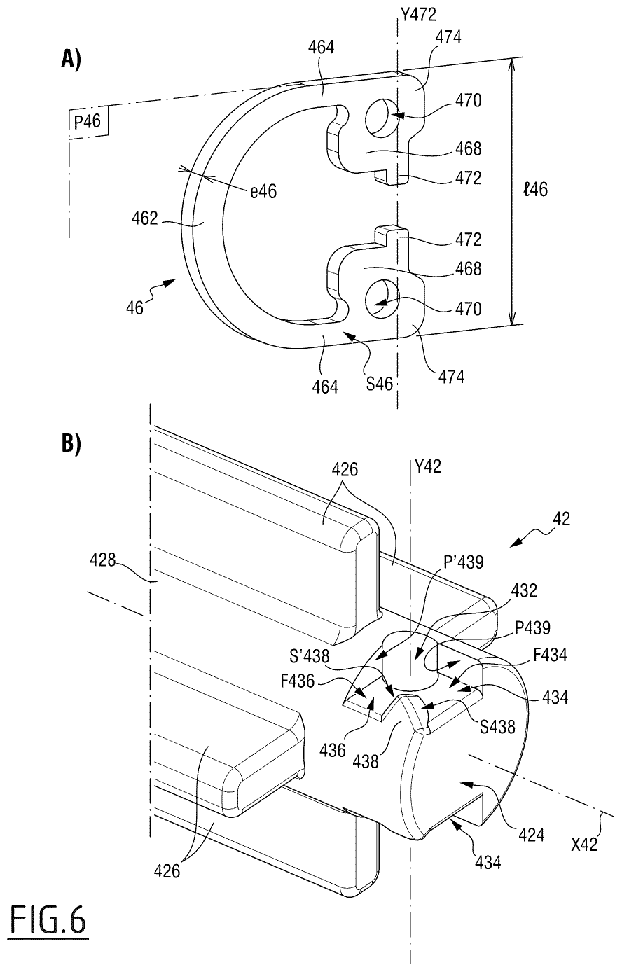

FIG. 6 represents, in two inserts A) and B) and on a larger scale, the pivoting lock and the end of the output shaft visible in FIGS. 3 to 5; and

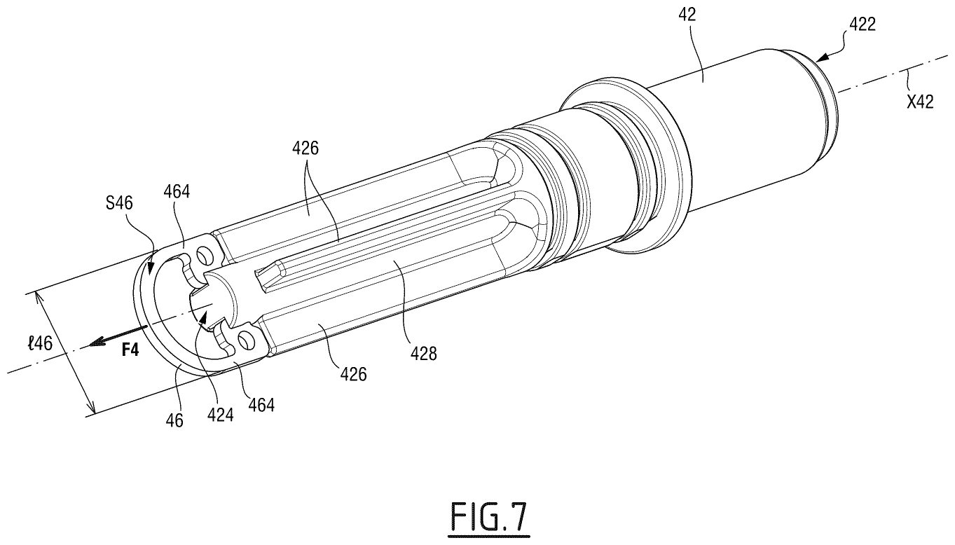

FIG. 7 is a perspective view of the pivoting lock and the output shaft, in the pre-mounted configuration of the pivoting lock on the output shaft.

First of all, referring to FIG. 1, an installation 1 is described, comprising a closure, concealment, or solar protection device 3 in accordance with a first embodiment of the invention. This installation 1 is implemented in a building represented by one of its walls M that includes an opening O in which a window or door, not represented, is arranged. This installation 1 is equipped with a screen 2 that belongs to the closure, concealment, or solar protection device 3, which constitutes, for example, a motorized blind.

The screen 2 is configured to at least partially conceal the opening O provided in the wall M, being in positions selected by a user, between a high end-of-travel position and a low end-of-travel position.

The closure, concealment, or solar protection device 3 is hereinafter referred to as the “concealment device” and comprises the screen 2. The expression “concealment device” thus covers closure or solar protection devices.

Here, the screen 2 can be formed of a fabric, woven or not, and comprises a load bar 4 which ensures tension of a part of the screen 2 unwound relative to a winding tube 6, movable in rotation around a winding axis X6 which is horizontal in the mounted configuration of the installation 1.

Depending on the rotation of the winding tube 6 around the winding axis X6, a more or less significant part of the screen 2 is unwound and suspended below the winding tube 6 and the load bar 4 is displaced vertically, in the direction of the double arrow F1 in FIG. 1.

An electromechanical actuator 10 is arranged in the winding tube 6 and comprises an electric motor 12 which is represented by its outline in FIG. 2. Advantageously, the electric motor 12 comprises a rotor and a stator, not represented, which are positioned coaxially around an axis of rotation X10 of the electromechanical actuator 10.

The axes X6 and X10 are coincident in the mounted configuration of the concealment device 3 within the installation 1.

Advantageously, the electric motor 12 is of the brushless type with electronic commutation, also called “BLDC” or “synchronous with permanent magnets.” Alternatively, the electric motor 12 can be a direct current or asynchronous motor, powered by alternating current.

The electromechanical actuator 10 also comprises an electronic control unit 14 configured to control the electric motor 12 from control commands received from a control unit 16, which can be a local or central, fixed or movable control unit. Preferably, the electronic control unit 14 is formed by an electronic board equipped with electronic components, comprising a microprocessor 15.

Advantageously, the control unit 16 is equipped with at least one selection element 18 and at least one display element 20. The control unit 16 also comprises a first remote communication module 22 able to emit, and possibly receive, electromagnetic signals S, particularly radio, to the electronic control unit 14 or coming from it.

In this regard, the electronic control unit 14 is equipped with a second communication module 24 able to receive electromagnetic signals S, particularly radio, and, possibly, to emit feedback signals to the control unit 16, in case of bidirectional communication between the electronic control unit 14 and the control unit 16.

Advantageously, to effectively communicate with the communication module 22, the communication module 24 is connected to an antenna, not represented, that extends partly in the winding tube 6 and partly outside the winding tube.

The electromechanical actuator 10 also comprises a reducer 32, a power source, such as a set of batteries 33, and a brake 34, which are represented by their respective outlines in FIG. 2.

The reducer 32 comprises at least one reduction stage, for example of the epicyclic type, or even of another type. The brake 34 allows to control the speed of rotation of the winding tube 6 around the winding axis X6 or to block the rotation of this tube.

Here, the set of batteries 33 is positioned, along the axis X10, between the electric motor 12 and the brake 34. Alternatively, in the invention, not represented, the set of batteries 33 can be positioned, along the axis X10, between the electric motor 12 and the electronic control unit 14. According to another alternative, not represented, the set of batteries 33 is positioned, along the axis X10, opposite the electric motor 12 relative to the electronic control unit 14.

Here, the brake 34 is positioned, along the axis X10, between the electric motor 12 and the reducer 32. Alternatively, in the invention, not represented, the reducer 32 can be positioned, along the axis X10, between the electric motor 12 and the brake 34. According to another alternative, not represented, the brake is positioned, along the axis X10, between two stages of the reducer 32.

The actuator 10 also comprises a casing 36 in which the elements 12, 14, 32, 33, and 34 are arranged and which extends between a first axial end 362, visible on the right of FIG. 2, and a second axial end 364 opposite the first axial end along the axis X10. The axial end 362 of the casing 36 is oriented on the same side as an axial end 62 of the winding tube 6 visible in FIG. 2.

The casing 36 is cylindrical in shape. It can be realized of metal or plastic material. The external diameter Φ36 of the casing 36 is strictly less than the internal diameter Φ6 of the winding tube. The electromechanical actuator is said to be tubular, in that the external diameter Φ36 of its casing 36 is much smaller than its axial length, taken along the axis X10.

In the example of the figures, the external diameter Φ36 is 25 mm. This gives good radial compactness to the electromechanical actuator 10, compatible with the winding tubes 6 of relatively small internal diameter Φ6, notably equal to 28 mm. However, the solution is also applicable to other external diameters of tubular electromechanical actuators.

A crown bearing 37 is arranged around the end 362 of the casing 36 and inside the end 62 of the winding tube 6 that it supports, with the possibility of rotation of the winding tube 6 around the axis X10, relative to the casing 36.

An actuator head 38 also belongs to the actuator 10 and allows to maintain it in position inside the winding shaft 6. The actuator head 38 is engaged in the casing 36, on the side of its first end 362.

The actuator head 38 notably allows to attach the actuator 10 to a support 40 which can be mounted on the wall M or on a flange of a box surrounding the winding tube 6 or on a support bracket, itself mounted on the wall or suspended from a ceiling. To this end, the actuator head 38 is provided with a housing 382 configured to receive one or more centering pins 402 carried by the support 40. The actuator head 38 therefore ensures, notably, a mechanical support function and load transfer for the electromechanical actuator 10. In addition, the actuator head constitutes a fixed point, or reference point, for the electric motor 12.

For clarity of the drawing, the support 40 and its pin 402 are only represented in FIG. 2, in chain dotted lines.

A cover 50, which is part of the electromechanical actuator 10, is attached, preferably removably, to the actuator head 38, on the side of this head opposite the casing 36.

An output shaft 42 of the electromechanical actuator 10 protrudes from the casing 36, opposite the actuator head 38, in other words, on the side of the second end 364 of this casing. The output shaft is configured to be driven in rotation by the electric motor 12, around the axis of rotation X10, through the brake 34 and the reducer 32. This output shaft 42 is equipped with a coupling wheel 44 rotationally integral, around the winding axis X6, of the winding tube 6.

A rotation of the output shaft 42 around the axis of rotation X10, resulting from the operation of the electric motor 12, has the effect of rotating the winding tube 6 around the winding axis X6 by means of the wheel 44, in one of two opposite directions of rotation, and unwinding or winding the screen 2 around the winding tube 6, by displacing the load bar 4 in one of the directions represented by the double arrow F1 in FIG. 1.

Thus, the winding tube 6 and the electromechanical actuator 10 belong to a motor-based driving device 8, which allows to selectively displace the screen 2 between positions chosen by the user of the concealment device 3.

The output shaft 42 comprises a first end 422 which is engaged in the casing 36 and which is integral, in rotation around the axis of rotation, with an output member of the reducer 32, as well as a second end 424 opposite the first end 422 which is arranged beyond the second end 364 of the casing 36 relative to the elements 12, 32, 33, and 34.

The longitudinal axis of the output shaft 42 is noted X42. In the mounted configuration of the electromechanical actuator 10, the axes X42 and X10 are coincident.

Advantageously, the output shaft 42 comprises four ribs 426 which are longitudinal, in other words, they extend parallel to the longitudinal axis X42, and which are regularly distributed, at 90°, around this axis. The ribs 426 are identical and extend, radially to the longitudinal axis X42 and centrifugally, from a hub 428 of the output shaft 42. Preferably, the output shaft 42 is monobloc.

The coupling wheel 44 extends according to a longitudinal axis X44 which is coincident with the longitudinal axes X10 and X42 in the mounted configuration of the electromechanical actuator 10. The axial length of the coupling wheel 44, measured parallel to the axis X44 is noted L44.

The coupling wheel 44 comprises external radial reliefs 442 equipped with external radial ribs 444. The assembly formed by the reliefs 442 and the ribs 444 is complementary to an internal radial surface S6 of the winding shaft 6, which allows to secure the winding shaft 6 and the coupling wheel 44, in rotation around the coincident axes X6 and X10 in the mounted configuration of the motor-based driving device 8 and the concealment device 3.

The coupling wheel 44 is provided with a central bore 445. In the example represented, the section of this central bore 445 is generally cross-shaped, with a central zone 448 corresponding to the hub 428 and four identical internal grooves 446 corresponding to the ribs 426. The central bore 445 can also be called a central opening.

The width of the bore 445 is noted [symbol] 445, measured perpendicular to the longitudinal axis X44 between the bottoms of two diametrically opposed grooves 446, and the width of one of the internal grooves is noted [symbol] 446. The dimensions [symbol] 445 and [symbol] 446 are chosen so that the hub 426 and the ribs 426 can pass through the coupling wheel 44 from one side to the other.

The complementary shape of the bore 445 relative to the hub 428 and the ribs 426 allows to secure in rotation the coupling wheel 44 on the output shaft 42, around the coincident axes X42 and X44, by shape cooperation. This securing by shape cooperation also allows the transmission of a rotational torque, from the ribs 426 toward the grooves 446. Thus, the wheel 44 ensures a kinematic connection between the output shaft 42 and the winding shaft 6. The complementary shape of the bore 445 is adapted relative to the hub 428 and the ribs 426, notably to the number and shape of the ribs 426.

The electromechanical actuator 10 also comprises a pivoting lock 46 mounted near the end 424 of the output shaft 42. By “near,” it is meant that a mounting zone of the lock 46 on the output shaft 42 is located, along the longitudinal axis X42 relative to the end 424, at less than 10% of the length of the output shaft.

The lock 46 is realized in an elastically deformable metal strip. For example, the metal in question can be steel or stainless steel. Alternatively, the lock can be realized in a plastic material.

The lock 46 is monobloc and generally or globally U-shaped, with a rounded bottom 462 and two branches 464 the free ends of which carry the plates 468. Each plate 468 is pierced with a bore 470 and comprises a lug 472. The two lugs face each other and extend toward each other from the plates 468. The lugs 472 are arranged at the ends of the branches 464 and aligned on a common axis Y472.

A median plane of the lock 46 is noted P46. This median plane extends equidistant from the lateral faces S46 and S′46 of the lock 46 which are respectively visible on insert A) and on insert B) of FIG. 3. The median plane is marked on FIGS. 4 and 6. The lateral face S46 is also visible in FIGS. 5 and 7, as well as on insert A) of FIG. 6. The trace of the lateral faces S46 and S′46 is also visible in FIG. 4.

The thickness of the lock 46 is noted e46, measured perpendicular to the median plane P46 and to the lateral faces S46 and S′46. The width of this lock is noted L46, measured between the ends of the branches 464, parallel to the median plane P46 and to the lateral faces S46 and S′46.

Two heels are noted 474 which are part of the plates 468 and extend, relative to the axis Y472, opposite the rounded bottom 432. The heels 474 are radially offset relative to the axis Y472.

Advantageously, the end 424 of the shaft 42 is provided with two housings for receiving the lugs 472, of which only one is visible on insert B) of FIG. 6, with the reference 432. The two housings, 432 and equivalent, are aligned on an axis Y42 which is radial to the longitudinal axis X42, and which forms a pivot axis of the lock 46 relative to the end 424 of the output shaft 42. In the mounted configuration of the electromechanical actuator 10, the axis Y42 is radial to the axis of rotation X10.

Advantageously, the two housings, 432 and equivalent, are diametrically opposed relative to the axis X42 and aligned on the axis Y42. Furthermore, their section is compatible with a rotational movement of the lugs 472 in these housings, around the axis Y42.

At the opening of each housing 432, the output shaft 42 is provided with a first notch 434 and a second notch 436 which communicate with the housing 432. The bottoms of the notches 434 and 436 are noted respectively F434 and F346, which are advantageously coplanar. The first and second notches are separated from each other by a relief 438, protruding relative to the bottoms F434 and F436.

A first surface of the relief 438 is noted S438, turned toward the first notch 434. A second surface of the relief 438 is noted S′438, turned toward the second notch 436. The surface S438 presents, relative to the bottom F434, a less marked degree of inclination than the surface S′438 relative to the bottom F346. In other words, the first surface S438 forms a chamfer that rises progressively relative to the bottom F434 of the first notch 434, while the second surface S′438 forms a sharp stop surface, almost orthogonal to the bottom F436 of the second notch 436.

When the lock 46 is mounted at the end 424 of the output shaft 42, with its lugs 472 received in the housings 432 and equivalent, the axes Y42 and Y472 are coincident and the lock can pivot around the axis Y42 and the axis Y472, between a first position and a second position.

In the first position represented on inserts A) of FIGS. 3 and 4 and in FIG. 7, the plates 468 are engaged, in other words, partially received, in the first notches 434. Advantageously, in this first position, each plate 438 bears in abutment both against the bottom F434 of a notch 434 and against a lateral support wall P439 which delimits the first notch 434 and which is parallel to the longitudinal axis X42. The angular orientation of the lock 46 is thus fixed.

The thickness e46 is strictly less than the width [symbol] 446, while the width [symbol] 46 is strictly less than the width [symbol] 445.

As a result, when the lock 46 is mounted on the output shaft and arranged in its first position, this as well as the hub 428 and the ribs 426 of the output shaft 42 can be introduced into the bore 445 and pass through the coupling wheel 44 from one side to the other.

The lock moves from its first to its second position by a rotation around the axes Y42 and Y472, by means of a temporary elastic deformation allowing the plates 468 to pass over the two reliefs 438, which causes the plates 468 to transition from the first notch 434 to the second notch 436 which adjoins each housing 432.

This rotation takes place over an angular amplitude α preferably equal to about 90°, which brings the lock 46 to bear in abutment against a transverse support wall P′439 which delimits the second notch 436 and which is perpendicular to the longitudinal axis X42. The angular amplitude α is visible in FIG. 4 by comparing the positions of the median plane P46 on insert B), where the representation of the lock in center lines, corresponds to its position on insert A). By about 90°, it is meant that the angular amplitude α is equal to about 90°±5°.

The difference in slope between the surfaces S438 and S′438 results in the protruding relief 48 opposing less to the pivoting of the lock 46 from its first position toward its second position than to the pivoting of this lock from its second position toward its first position.

Advantageously, in the first position of the lock 46, the median plane P46 is parallel to the axis X42, therefore to the axis X10 in the mounted configuration of the actuator 10. On the other hand, in the second position of the lock 46, the median plane P46 is perpendicular to the longitudinal axis X42, therefore to the axis of rotation X10 in the mounted configuration of the actuator.

In its second position, the lock 46 opposes the extraction of the coupling wheel 44 relative to the output shaft 42, in the direction of the arrow F5 on insert B) of FIG. 3. In other words, the lock 46 maintains the coupling wheel in the axial position on the output shaft 42.

In the second position of the lock 46, the heels 474 are in abutment by means of the surface S46, against a frontal surface S44 of the coupling wheel 44 which is opposite the elements 12, 14, 32, 33, and 34 in the mounted configuration of the coupling wheel on the output shaft 42. This surface contact between the surfaces S46 and S44, at the heels 474, in other words, in a zone radially offset relative to the axes Y42 and Y472, induces a resisting torque to the pivoting of the lock 446, from its second position toward its first position. Thus, the lock 46 is not at risk of being accidentally pivoted, from its second position to its first position, by a simple pull on the coupling wheel 44, in the direction of the arrow F5. To pivot the lock 46 from its second position toward its first position, it is necessary to exert on the rounded bottom 462 a sufficient torque to overcome the resisting torque due to the heels 474.

A method for assembling the electromechanical actuator 10 begins by pre-mounting the lock 46 at the end 424 of the output shaft, in its first position, which allows to achieve the configuration of FIG. 7.

The bores 470 can be used during the placement of the lock 46 on the output shaft 42, in order to spread the plates 468 apart from each other and facilitate the engagement of the lugs 472 in the housings 432. The manipulation of the lock 46 through the bores 470 can be carried out with circlip pliers.

Then, the end 424 of the output shaft 42 equipped with the lock 46 is engaged inside the central bore 445 of the coupling wheel 44, in the direction of the arrows F4 in FIGS. 5 and 7.

In the example represented, when it is in its first position, the lock 432 is arranged in the extension of two of the diametrically opposed ribs 426, according to directions parallel to the longitudinal axis X42, so that it does not disturb the introduction of the output shaft 42 into the bore 445 and the passage of this bore by the end 424 of this output shaft. This is possible because the thickness e46 is strictly less than the width [symbol] 446 and because the width [symbol] 46 is strictly less than the width [symbol] 445.

The position represented on the inserts A) of FIGS. 3 and 4 is then reached, where the lock 46 projects from the coupling wheel 44, opposite its entry side into the bore 445 extending parallel to the axes X42 and X44.

It is then possible to fold down the lock 46 in the direction of the coupling wheel 44, in the direction of the arrow F6 in FIG. 4, which has the effect of bringing the lock 46 into its second position, wherein it is effectively retained due to the stop formed by the sharp stop surfaces S′438 of the two reliefs 438.

The pivoting of the lock in the direction of the arrow F6 is easy to implement and can be carried out by hand.

In its second position, the lock 46 opposes a relative movement in the direction of the arrow F5, between the parts 42 and 44, in the opposite direction to the movement of introduction of the output shaft 42 into the bore 445. In other words, it maintains the coupling wheel 44 in a given position relative to the output shaft 42.

A distance is noted d42 between, on the one hand, the end of the ribs 426 on the side of the second end 424 of the output shaft 42 and, on the other hand, a junction between the ribs 426 and an external part of the hub 428, opposite this second end 424, this junction forming a stop for the coupling wheel 44 when it is threaded onto the output shaft 42. The distance d42 is chosen to be substantially equal to the length L44. Thus, once the lock 46 is folded into its second position, the coupling wheel 44 cannot be displaced, with a significant amplitude, along the output shaft 42.

In the configuration of the inserts B) of FIGS. 3 and 4, the axial retention force of the coupling wheel 44 on the output shaft 42 is exerted by the two plates 468, on either side of the axes X42 and X44, therefore of the axis of rotation X10 in the mounted configuration of the actuator 10. Furthermore, the heels 474 exert a resisting torque to the pivoting of the lock 46, from its second position toward its first position. This contributes to a stabilization of the obtained retention force.

Even if the axial retention obtained in the second position of the lock 46 is firm, it remains possible to bring the lock back to its second position when the coupling wheel 44 must be dismantled from the output shaft 42, for example during a maintenance operation of the electromechanical actuator 10. In this case, a pivoting of the lock around the coincident axes Y42 and Y472 is implemented in the opposite direction to the arrow F6. This requires the plates 468 to cross the protruding reliefs 438, under the effect of a more intense effort than that necessary during the pivoting in the direction of the arrow F6, given the more marked inclination of the stop surface S′438 relative to the bottom F436, than that of the chamfer S438 relative to the bottom F434. This more intense effort must only be applied in case of dismantling, in the context of an easy and intuitive operation for an operator, an operation that can be carried out manually, without tools.

The invention is represented in the case where the coupling wheel 44 comprises a main part 44A at the periphery of which the reliefs 442 are arranged and a secondary part 44B in the form of a cross. This is not mandatory and the coupling wheel 44 may only comprise a part 44A or, on the contrary, a part 44B at each end of the part 44A.

The invention is represented in the case where two notches 434 and 436 for partial reception of the plates 468 and two reliefs 438 are provided at the opening of each housing 432 and equivalent. According to one alternative, such notches are provided at the opening of only one of these housings. According to another alternative, only one relief 438 is provided.

Any feature described above for one embodiment or alternative is applicable to other embodiments and alternatives, as long as it is technically possible.

1. An electromechanical actuator (10) of a concealment device (3), this actuator comprising at least:
an electric motor (12) configured to drive an output shaft (42) of the actuator in rotation around an axis of rotation (X10);
a kinematic coupling wheel (44) between the output shaft and a winding tube (6) of a screen (2),
characterized in that the output shaft (42) is equipped with a lock, pivoting around a radial pivot axis (Y42) to the axis of rotation (X10) between a first position, compatible with the placement (F4) of the coupling wheel (44) on the output shaft, and a second position, for maintaining the coupling wheel in axial position on the output shaft.

2. The electromechanical actuator according to claim 1, wherein the lock (46) is an elastically deformable and globally U-shaped metal strip.

3. The electromechanical actuator according to claim 1, wherein the lock (46) is of the circlip type.

4. The electromechanical actuator according to claim 1, wherein the angular amplitude (α) of pivoting of the lock (46), around the pivot axis (Y42), between its first and second positions, is about 90°, wherein a median plane (P46) of the lock (46) is parallel to the axis of rotation (X10) when the lock is in its first position and wherein the median plane of the lock is perpendicular to the axis of rotation when the lock is in its second position.

5. The electromechanical actuator according to claim 1, wherein the lock (46) comprises two lugs (472) and wherein the output shaft (42) comprises two diametrically opposed housings (432) configured to receive the lugs, with the possibility of rotation of the lugs (472) in the housings (432), allowing the pivoting of the lock between its first and second positions.

6. The electromechanical actuator according to claim 5, wherein the lock (46) is an elastically deformable and globally U-shaped metal strip and wherein the lugs (472) are arranged on plates (468) arranged at the ends of the branches (464) of the globally U-shaped metal strip, face each other and extend in the direction of each other.

7. The electromechanical actuator according to claims 5, wherein
each lug (472) extends from a plate (468) of the lock (46);
the output shaft (42) defines at least a first notch (464) for partial reception of a plate (468) when the lock is in its first position;
the output shaft defines at least a second notch (4326) for partial reception of the plate when the lock is in its second position and
a protruding relief (438) separates the first and second notches.

8. The electromechanical actuator according to claim 7, wherein the protruding relief (438) is delimited by a chamfer (S438) on the side of the first notch (434) and by a stop surface (S′438) on the side of the second notch (436) and wherein the protruding relief opposes less to the pivoting of the lock (46) from its first position to its second position than to the pivoting of the lock from its second position to its first position.

9. The electromechanical actuator according to claim 1, wherein the output shaft (42) comprises ribs (426) for torque transmission to the coupling wheel (44), which is equipped with internal grooves (446) for receiving the ribs of the output shaft, and wherein, when it is in its first position, the lock (46) is in the extension of at least one rib of the output shaft.

10. A motor-based driving device (8) for driving a screen (2) of a concealment device, between at least a first position and at least a second position, comprising a winding tube (6) of the screen and an actuator (10) according to claim 1, the coupling wheel (44) of which is integral in rotation with the winding tube, around the axis of rotation (X10).

11. A concealment device (3) comprising
a movable screen (2) between at least a first position and at least a second position;
a motor-based driving device (8) for the screen between its first and second positions, which is according to claim 10.

12. A method for assembling an electromechanical actuator (10), wherein
a) a pivoting lock (46) is pre-mounted at one end (424) of an output shaft (42) of the electromechanical actuator, in a first position, compatible with the placement of a coupling wheel (44) on the output shaft,
b) an end of the output shaft equipped with the pivoting lock (46) is engaged in a central bore (445) of the coupling wheel,
c) the coupling wheel is axially locked on the output shaft by pivoting (F6) the pivoting lock, around a radial axis (Y42) to an axis of rotation (X10) of the output shaft, between its first position and a second position for maintaining the coupling wheel (44) in axial position on the output shaft (42).
